(19) United States
(12) Patent Application Publication
(10) Pub. No.: US 2007/0259768 A1
(43) Pub. Date: Nov. 8, 2007

(54) Nanocomposite ceramic and method for producing the same

(76) Inventors: Bernard H. Kear, Whitehouse Station, NJ (US); Bryan W. McEnerney, Flemington, NJ (US); Dale E. Niesz, Westerville, OH (US); Rajendra K. Sadangi, Edison, NJ (US)

Correspondence Address: Kenneth Watov;WATOV & KIPNES, P.C., P.O. Box 247, Princeton Junction, NJ, 08550, US

(21) Appl. No.: 11/595,086

(22) Filed: Nov. 9, 2006

Related U.S. Application Data
(60) Provisional application No. 60/796,859, filed on May 3, 2006.

(51) Int. Cl. C04B 35/053; C04B 35/117; B29B 9/00; C04B 35/04; C04B 35/00; C04B 35/64

(52) U.S. Cl. 501/120; 501/127; 501/153; 264/6; 264/12; 264/667

(57) ABSTRACT

A nanocomposite ceramic includes a uniform combination of a ceramic spinel phase and an alumina phase, wherein each phase exhibits a grain size in the range of from about 0.1 nm to 10,000 nm.

### RELATED APPLICATIONS

This Application claims priority benefit under 35 U.S.C. 119(e) of U.S. Provisional Application No. 60/796,859, filed on May 3, 2006. The present Application is also related to U.S. patent application Ser. No. 11/259,299, entitled “Composite Ceramic Having Nano-Scale Grain Dimensions and Method For Manufacturing the Same,” filed on Oct. 26, 2005; to U.S. patent application Ser. No. 11/360,226, entitled “Shrouded-Plasma Process and Apparatus for the Production of Metastable Nanostructured Materials,” filed on Feb. 23, 2006; and to U.S. patent application Ser. No. 11/360,229, entitled “Nanocomposite Ceramics and Process for Making the Same,” filed Feb. 23, 2006. The teachings of the aforesaid Provisional and three related Non-Provisional Applications are incorporated herein by reference to the extent that they do not conflict herewith.

### GOVERNMENT INTEREST

The U.S. Government has a paid-up license in this invention and the right in limited circumstances to require the patent owner to license others on reasonable terms as provided for by the terms of Federal Funding Grant No. DAAD-19-04-2-0004, awarded by the Army Research Laboratory.

### FIELD OF THE INVENTION

The present invention relates generally to ceramic composites, and more specifically to nanocomposite ceramics and a method for producing the same.

### BACKGROUND OF THE INVENTION

Composite materials are engineered materials made from two or more constituent materials that remain separate and distinct while forming a single component. The fused constituents impart special physical properties including mechanical and electrical that enhance the resulting product. A synergism produces material properties typically unavailable from naturally occurring single constituent materials. Due to the wide variety of constituent materials available, the design potential is considerable. Some advanced examples perform routinely on aerospace vehicles in demanding environments. Some visible applications pave roadways in the form of steel and portland cement concrete or asphalt concrete. Some common applications are found in the form of home products including, but not limited to, shower stalls and bathtubs fabricated from fiberglass, and sinks and countertops made of imitation granite or cultured marble.

Ceramic materials are known to exhibit excellent performance such as hardness, wear resistance, heat resistance, and corrosion resistance. However, for the actual use of ceramic materials such as armor, it is desirable to develop a ceramic material having a good balance of hardness, strength and toughness (i.e., fracture resistance). Ceramic materials with such properties are typically associated with those having long-range ordered structures with small grain sizes. Such ceramic materials are often referred to as nanocomposite ceramics. Over a decade of research has been invested into studying this promising class of materials.

Such nanocomposite ceramics are produced from metastable or amorphous phases that yield a composite structure with micro-scale to nano-scale grain sizes through controlled phase transformation during sintering. It has been found that reduction of the grain size of ceramic components down to the micro-scale or nano-scale dimensions significantly enhances the physical properties of ceramic materials. Initial focus was directed to processing of single phase or nanocrystalline ceramics such as, for example, α-alumina (α-Al₂O₃) or rutile-titanium oxide (TiO₂) through densification techniques including pressure sintering. Conventional densification techniques have a tendency to generate explosive uncontrolled grain growth due to the presence of a high driving force. Such high driving force is usually the result of an inherent large surface area of the amorphous intermediate materials. Very high pressures of from about 4 to 8 GPa are needed to provide adequate densification, while averting or substantially minimizing uncontrolled grain growth. This greatly limits the size for fabricating such nanocomposite ceramics.

Advances in ceramics have led to fabrication of nanocomposite ceramics where the amorphous or metastable intermediate material is composed of two or more stable ceramic phases. Such ceramic compositions exhibited a natural tendency to resist undesirable grain growth or coarsening especially at elevated temperatures during densification. It has been theorized that each phase in the material prevents or obstructs the grain growth of adjacent phases, especially in materials comprising equal volume fractions of the respective phases. This effectively reduces sintering pressures to the range of from about 0.1 to 0.3 GPa to produce nanocomposite ceramics exhibiting micro-scale to nano-scale grain sizes.

Accordingly, there is a need to develop a nanocomposite ceramic having a micro-scale to nano-scale grain structure comprising an alumina phase and at least one other phase such as spinel, in equilibrium wherein the individual grains have an average grain size of less than 10,000 nm, and preferably less than 100 nm. There is a further need for a nanocomposite ceramic exhibiting a balance of high hardness and low density useful for a range of applications, including, but not limited to, armor applications.

### SUMMARY OF THE INVENTION

The present invention relates to an alumina-spinel based nanocomposite ceramic exhibiting a unique grain structure at micro-scale to nano-scale levels. The novel structure of the present invention provides the material with high hardness and exceptional strength under high strain rate loading conditions. The nanocomposite ceramic of the present invention is a promising material for a range of applications requiring high hardness while exhibiting good fracture resistance, including, but not limited to, armor applications. The nanocomposite ceramic of the present invention comprises a micro-scale to nano-scale grain structure comprising an alumina phase and at least one spinel phase in equilibrium wherein the individual grains have an average grain size of less than 10,000 nm, and preferably less than 100 nm.

The present invention further extends to a method for producing the alumina-spinel based nanocomposite ceramic. The method includes forming a metastable or amorphous intermediate material which may be in the form of a powder, coating or preform, through the melting and quenching of a conventional mixture of an alumina phase and a spinel phase as a ceramic starting or feed material. During the melting and quenching process, the ceramic feed material is melted and homogenized to yield molten particles. The molten particles are then rapidly solidified to yield the metastable or amorphous intermediate material, which can be in the form of a powder, coating or preform.

The metastable intermediate material is then pressure sintered such as hot isostatic pressing to fully densify the material into a nanocomposite ceramic having a micro-scale to nano-scale grain structure. The pressure sintering process is preferably implemented using a transformation assisted consolidation (TAC) process, which utilizes high pressures and relatively low temperatures to initiate the densification and transformation of the metastable intermediate material. The resulting densified product exhibits a novel nanocomposite structure generated by a combination of solid state diffusion and nucleation-precipitation mechanisms.

The nanocomposite ceramic comprises an alumina-spinel combination that performs well under high strain rate conditions. The nanocomposite ceramic of the present invention exhibited higher hardness than would be expected under the rule of mixtures, presence of fine-scale “accommodation twins” in the nanophase alumina, which may contribute to the enhanced toughness due to extensive cracking under high stresses, particularly in composites with a bicontinuous structure, and enhanced plasticity due to ease of nucleating slip and twinning at the many interphase boundaries in the composite. The nanocomposite ceramic of the present invention further exhibits surface localized plastic deformation zones. Applicants believe that such deformation zones are capable of producing very fine-scale fracturing that extends over a large area when encountering large impact forces. This results in efficient absorption of high impact energy while maintaining an intact structure, which is especially useful for armor applications.

In one aspect of the present invention, there is provided a nanocomposite ceramic comprising a uniform combination of at least two hard ceramic phases, wherein each phase exhibits an average grain size of less than 10,000 nm.

In another aspect of the present invention, there is provided a method for fabricating the above nanocomposite ceramic, comprising:

transforming a ceramic feed material comprising at least two hard ceramic phases into a metastable crystalline phase having an amorphous, short-range order structure; and

sintering the metastable crystalline phase under elevated pressures and temperatures for a sufficient time to yield the nanocomposite ceramic.

### BRIEF DESCRIPTION OF THE DRAWINGS

The following drawings, in which like items may have the same reference designations, are illustrative of embodiments of the present invention and are not intended to limit the invention as encompassed by the claims forming part of the application, wherein:

FIG. 1 is a schematic of a plasma melt-quenching system illustrating the production of metastable or amorphous intermediate materials in one embodiment of the present invention;

FIG. 2 is a schematic of a shrouded plasma melt-quenching system illustrating the production of metastable or amorphous intermediate materials in another embodiment of the present invention;

FIG. 3A is a graph showing the hardness values of a nanocomposite ceramic having a volume ratio of alumina:spinel of 60:40 over applied loads in accordance with the present invention;

FIG. 3B is a graph comparing the hardness data for the nanocomposite ceramic of FIG. 3A with data obtained from several commercially available ceramic-based armor products;

FIG. 4A is a graph indicating hardness versus load of composites produced after pressure-less sintering at 1600° C. and subsequently hot isostatically pressed at 1375° C. in accordance with the present invention;

FIG. 4B is a graph indicating hardness versus load of composites produced after composites produced after sintering at 1600° C. and post-hot isostatic pressing at 1375° C.; and

FIG. 5 is a graph showing the high strain rate behavior of alumina-20 vol. % MgAl₂O₄ in accordance with the present invention.

### DETAILED DESCRIPTION OF THE INVENTION

The present invention is directed to an alumina-spinel based nanocomposite ceramic exhibiting a unique grain structure at micro-scale to nano-scale levels. The novel structure of the present invention provides the material with high hardness and exceptional strength under high strain rate loading conditions. The nanocomposite ceramic of the present invention is a promising material for a range of applications requiring high hardness while exhibiting good fracture resistance, including, but not limited to, armor applications.

The nanocomposite ceramic of the present invention comprises a micro-scale to nano-scale grain structure comprising an alumina phase and at least one other phase, such as spinel, in equilibrium wherein the individual grains have an average grain size of less than 10,000 nm, and preferably less than 100 nm. The nanocomposite ceramic of the present invention is produced from treating metastable intermediate or amorphous materials composed of alumina and spinel phases at various volume ratio amounts to elevated pressures and temperature for a sufficient time period to induce densification and phase transformation as will be further described hereinafter.

The novel class of alumina-spinel based nanocomposite ceramics maintains both high hardness and good fracture resistance. The nanocomposite ceramic can exhibit a particle-dispersed structure or a bi-continuous structure depending on the volume fraction of the respective phases in the ceramic starting or feed material. In a preferred embodiment, the nanocomposite ceramic comprises a bicontinuous structure in which the contiguous constituent phases are arranged in an interwoven relationship in three dimensions, thus enhancing resistance to grain growth or coarsening, particularly at high temperatures.

The methods of the present invention have been found to afford considerable flexibility in tailoring the properties of the nanocomposite ceramic to meet the performance requirements of a range of applications. Furthermore, the novel class of hard and tough alumina-spinel based nanocomposite ceramics can be employed in a range of potential applications, including, but not limited to, armor applications. The different forms and shapes of products fashioned out of the present invention can be fabricated through conventional powder processing techniques such as, for example, tape casting for forming thin sheets, slip casting for forming hollow parts, die pressing or injection molding for forming solid parts and the like.

The fabrication of the nanocomposite ceramic utilizes a two-step method. The two-step method includes transforming through a melt-quenching treatment a conventional aggregated ceramic starting or feed material composed of an alumina phase and a spinel phase into a metastable intermediate material having an amorphous, short-range ordered structure, and thereafter subjecting the metastable intermediate material to elevated pressures and temperature for a sufficient time period to yield the nanocomposite ceramic. The resulting nanocomposite ceramic comprises an equilibrium two-phase structure of alumina and a spinel having an average grain size of less than 10,000 nm, and preferably less than 100 nm.

The pressure of the pressure sintering process is in the range of from about 0.1 to 5 GPa, and preferably from about 0.1 to 3 GPa. The temperature of the pressure sintering process is in the range of from about 25% to 60% of the melting point of the metastable intermediate material. The pressure sintering time is in the range of about at least 15 minutes, preferably 2 to 14 hours and more preferably 2 to 8 hours.

The term “spinel” is intended to encompass any class of minerals, which crystallize in the isometric system with an octahedral habit, and follows the general formula (X²⁺)(Al²⁺)₂(O²⁻)₄ with X representing a divalent cation. The divalent cation can be selected from magnesium, zinc, iron or manganese. In a preferred embodiment, the spinel is magnesium aluminum oxide (MgAl₂O₄). The term “spinel” generally refers to any oxide that is capable of thermally decomposing into a corresponding spinel in the presence of alumina during densification or pressure sintering, and is preferably selected from magnesium (II) oxide (MgO), zinc (II) oxide (ZnO), iron (II) oxide (FeO), and manganese (II) oxide (MnO). In a preferred embodiment of the present invention, the spinel is magnesium (II) oxide.

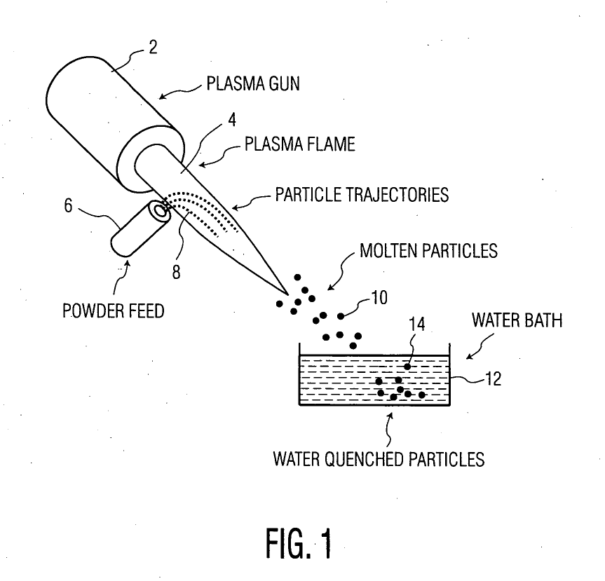

Referring to FIG. 1, there is shown a schematic of a plasma melt-quenching system 1 for one embodiment of the present invention. The system 1 includes a plasma gun 2 such as a standard commercially available Sulzer-Metco DC arc-plasma torch, generating a plasma flame 4 as a high enthalpy heat source. The plasma gun 2 includes a side injection port 6 through which a feed powder 8 such as, for example, a slurry mixture of alumina (Al₂O₃) and magnesium oxide (MgO), a spinel, is delivered into the plasma flame 4. The aggregated feed powder 8 is injected into the high enthalpy plasma flame 4 to induce complete particle melting and homogenization. The heated gas stream produced by the plasma flame 4 carries the feed powder 8 in the form of molten particles 10 to a water bath 12. The molten particles 10 are rapidly cooled upon contact with the water bath 12 and transform into water quenched particles 14. Typically, portions of the feed powder 8 may require repeated passing through the plasma flame 4 for a thorough melt to obtain a homogeneous metastable form. Generally, two or three such treatments are sufficient to ensure complete conversion of the feed powder into a metastable powder.

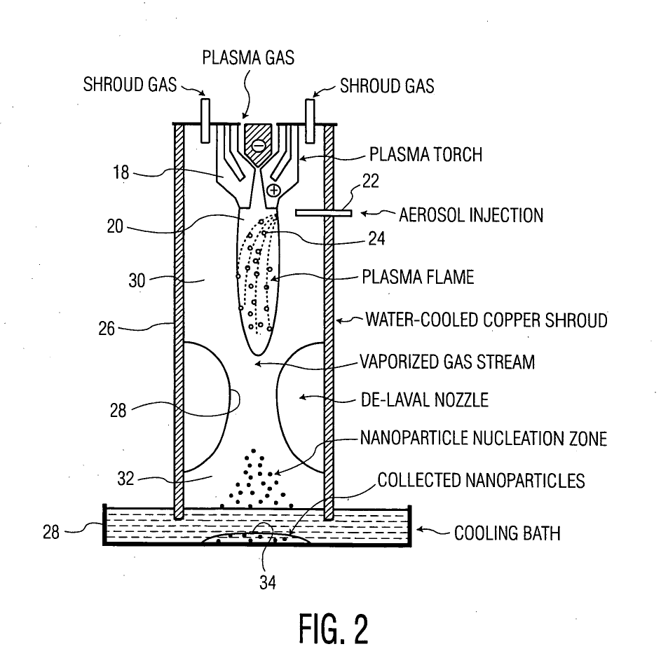

Referring to FIG. 2, there is shown a schematic of a shrouded DC-arc plasma system 16 for implementing a shrouded plasma melt-quenching process. The system 16 is designed to efficiently produce a metastable intermediate material from an aggregated feed material for fabrication of the nanocomposite ceramic of the present invention. The system 16 includes a high enthalpy arc-plasma torch 18 for generating a plasma flame 20 as the heat source, and a feed injection element 22 for supplying an aggregated feed material 24 into the plasma flame 20 for melting. Generally, the feed material 24 is delivered to a steady-state reaction zone within the plasma flame 20, where rapid and controlled precursor decomposition occurs. Depending on the operating conditions, the feed material 24 is pyrolized, melted or vaporized, prior to quenching to form a metastable product with an amorphous or short-order range structure.

The aggregated feed material 24 can be in the form of a solution precursor, a slurry or an aggregated powder. In one embodiment, the feed material 24 is supplied in the form of an aerosol- or liquid-spray comprising a solution precursor. Accordingly, the metastable intermediate material obtained is typically related to the form of the feed material 24 processed. Variables including aerosol composition, particle size, flow rate, carrier gas, plasma power, gas composition and flow rate, and feed material delivery system can be adjusted to produce a specific metastable powder with select particle size, distribution, morphology, or a specific metastable deposit with a porous or dense structure.

For example, microsized metastable intermediate material can be obtained from an aggregated feed powder (typically 10 to 200 μm particle size) utilizing a prolonged feed-particle residence time to ensure more efficient processing. Nano-sized metastable powder can be obtained from vapor-condensation process utilizing a fine-particle aerosol (typically 0.1 to 50 μm particle size) of solution precursor as feed material 24. The aerosol is efficiently vaporized, and a metastable intermediate material is produced upon rapid solidification. With the processing of the fine-particle aerosol, the increased residence time enables complete vaporization of all the feed material 24, prior to rapid condensation of the vaporized species in a cooling medium to generate a metastable intermediate material.

The system 16 further includes a shroud 26 surrounding and enclosing the plasma flame 20. The shroud 26 is generally tubular in shape and extends from the plasma torch 18 to a quenching medium 28 in the form of a cooling bath. The shroud 26 can be composed of any heat resistant or refractory material including ceramics, metals such as copper, carbon-based composites including graphite and the like. The shroud 26 efficiently retains the radiant energy generated by the plasma flame 24 that would otherwise be released to the surroundings. In this manner, the interior of the shroud 26 can be rapidly heated to a very high temperature. The shroud 26 further operates to facilitate a uniform reaction zone in the plasma flame 20, which enhances the complete and uniform conversion of the feed material 24 into a homogenous metastable intermediate material in the form of a powder, coating, deposit or preform.

The exterior of the shroud 26 is preferably cooled with a flowing gas or liquid to establish a uniform temperature gradient through the wall of the shroud 26. This forms a hot walled reactor where high temperature can be sustained by the intense radiation from the plasma flame 20. The heat generated by the plasma flame 20 and the radiant energy refracted from the shroud 26 facilitates rapid and efficient conversion of the feed material 24 into a metastable intermediate material.

The system 16 further includes a nozzle 28 attached to the lower interior end of the shroud 26. The nozzle 28 partitions the interior of the shroud 26 into a high pressure upper region 30 and a lower pressure low region 32. As the melted feed material 24 moves from the upper region 30 through the nozzle 28, the feed material 24 undergoes rapid adiabatic cooling as it enters the lower region 32. This greatly increases the velocity of the melted feed material 24 toward the quench medium 28. As the feed material 24 passes through the lower region 32 and into the quench medium 28, the feed material 24 undergoes rapid cooling and is transformed into a desired metastable intermediate material 34 with an amorphous short-range order structure.

When quenched in the quench medium 28 (e.g., cooling water bath), the surface of the feed material 24 experience surface chemical reactions, specifically hydrolysis. X-ray diffraction analysis detects the presence of such surface reactions by the appearance of an amorphous peak superimposed on the crystalline spinel peaks in the diffraction pattern of the as-quenched powder. In a subsequent X-ray diffraction analysis, the amorphous peak is absent after the as-quenched powder was annealed in dry argon at about 500° C. for about 2 hours. After the annealing treatment, a sharp reduction in weight is observed over the temperature range starting from about 150° C. This effect is more pronounced for the nanopowder since the material has a much higher surface area. The micro-sized metastable power having less surface area is less vulnerable to such surface reaction losses.

In one embodiment of the present invention, there is provided a method for producing the alumina-spinel based nanocomposite ceramic. The method includes forming a metastable or amorphous intermediate material in the form of a powder, coating or preform, through the melting and quenching of a conventional mixture of an alumina phase and a spinel phase as a ceramic starting or feed material in the range of 0 to 100 volume percent for each phase. During the melting and quenching process, the ceramic feed material is melted and homogenized to yield molten particles. The molten particles are then rapidly solidified to yield the metastable or amorphous intermediate material, which can be in the form of a powder, coating or preform.

The aggregated ceramic starting or feed material can be in the form of a powder or aerosol generated from a precursor solution. The term “solution precursor” is intended to encompass any aqueous or organic solution of mixed salts including nitrates, chlorides, acetates, oxalates, phosphates, sulfates, and the like which forms into a desired ceramic phase (e.g., alumina or a spinel) upon thermal decomposition. Typically, standard powder feeds for plasma spraying have particle sizes in the range of 0.1 to 200 micrometers, preferably 0.1 to 50 micrometers and more preferably 10 to 50 micrometers. Such powders are normally produced by mechanical mixing of the constituent phases in a fluid medium, followed by spray drying to produce an agglomerated powder. During the melt-quenching process, the ceramic starting material is fed continuously into the hot zone of a plasma flame or a suitable high enthalpy heat source. Rapid melting of the powders or vaporization of the aerosol occurs, followed by rapid quenching or solidification on a cold substrate. Where the cold substrate is a cooling bath, the molten particles are cooled and remain discrete particles. When the cold substrate is a surface, the large impact forces created as the molten particles arrive at the substrate surface promote strong particle-substrate adhesion and the formation of a dense coating or preform.

In a more preferred embodiment of the present invention, a fine-particle slurry of Al₂O₃ and MgO phases having particle sizes of from about 0.1 to 200 micrometers, preferably 0.1 to 50 micrometers and more preferably 0.1 to 50 micrometers is spray dried to yield an aggregated feed powder. The feed powder is then heat treated to remove the organics and moisture, and to strengthen the particle aggregates. The feed powder is then passed through a plasma flame where it is thoroughly melted, and rapidly cooled to yield a homogeneous metastable intermediate material in the form of a powder.

The metastable intermediate material is pressure sintered (i.e., hot isostatically pressed) to fully densify the material into a nanocomposite ceramic having a micro-scale to nano-scale grain structure. The pressure sintering process is preferably implemented using a transformation assisted consolidation (TAC) process, which utilizes high pressures and relatively low temperatures to initiate the densification and transformation of the metastable intermediate material. The resulting densified product exhibits a novel nanocomposite structure generated by a combination of solid state diffusion and nucleation-precipitation mechanisms.

The high pressure and low temperature consolidation process completes densification of the as-quenched metastable intermediate material, while simultaneously developing a completely uniform micro-scale to nano-scale grain structure by a pressure-induced phase transformation mechanism. The pressure of the pressure sintering process is in the range of from about 0.1 to 5 GPa, and preferably from about 0.1 to 1 GPa, and more preferably from about 0.1 to 0.3 GPa. The temperature of the pressure sintering process is in the range of from about 25% to 60% of the melting point of the metastable intermediate material.

In a preferred embodiment of the present invention, the following procedure was adopted to produce a nanocomposite ceramic by pressure-assisted sintering of a metastable intermediate material in the form of a powder compact: (1) selection of the smaller size fraction of less than 200 μm dia., preferably less than 50 μm dia., and more preferably less than 30 μm dia. of the melt-quenched metastable powder; (2) cold isostatic pressing (CIP) to obtain a moderately-dense powder compact, (3) encapsulating the powder compact in a low carbon steel container, with boron nitride as parting compound, (4) thorough vacuum degassing of the encapsulated material at 300° C. for 1 hr., and (5) hot isostatic pressing (HIP) at 1250 to 1400° C. for 2 to 8 hrs. for consolidating the material, taking advantage of the superplastic-like behavior displayed by the compacted powder when phase decomposition commences. An important consequence of this behavior is the ability to densify the metastable intermediate material at relatively low sintering temperatures.

TAC has proven to be a useful method for consolidating nano-scale powders to produce a fully sintered end product which retains the nano-scale grain size and all the advantages associated with finer microstructures. A key component of the method of the invention is the utilization of the metastable intermediate material that undergoes a phase transformation during sintering. Since most transformations are a nucleation and growth process, both processes can be controlled by a suitable choice of temperature and pressure. Diffusion rates can be reduced for example, by lowering the temperature and raising the applied pressure. Also, the nucleation rate can be increased by increasing the pressure, and to some extent by lowering the temperature. Lowering the diffusion rate will slow down the kinetics, while increasing the nucleation rate of the stable phase(s) will result in a finer sintered grain size. Thus, a combination of high pressure and low temperature is desired for optimum control.

The method of the present invention can be used to make a wider range of nano-scale composite ceramics than prior art methods which produce metastable starting powders by rapid condensation from the vapor state utilizing Chemical Vapor Condensation (CVC) process. This is because metastable intermediate material, produced by the present method's rapid solidification from the liquid state process, can be made from a wide range of ceramic powders, including powder mixtures, that can be plasma melted and splat quenched in accordance with the present invention to generate a metastable crystalline or amorphous material.

Rapid solidification of the molten ceramic powder in the first step of the present method is preferably accomplished by quenching the same on an inclined water-cooled copper chill plate to develop cooling rates of ˜10⁶° K/sec, so that the resulting “splat-quenched” material displays little or no chemical segregation. The angular range of the inclined chill plate is preferably at least 10 degrees from the normal and the temperature of the plate is preferably less than 150° F. Cooling rates of ˜10⁶° K/sec are preferred because they ensure a homogeneous metastable intermediate material, i.e., a product that has experienced plane-front, segregation-less solidification. It should be understood, however, that cooling rates as low as ˜10⁴° K/sec can also be used in the present invention for rapid solidification, although the quenched material may include some deleterious primary solidification phases. Such cooling rates are typically obtained by spraying into room temperature water. Cooling rates between ˜10⁵° K/sec and ˜10⁶° K/sec can be obtained by spraying onto uncooled steel substrates.

The metastable intermediate material can be produced in powder form, as a coating, or as a preform. In an alternative embodiment of the present invention, powders of metastable intermediate material are produced by spraying the molten droplets of ceramic powder onto an inclined (about 45 degrees from the normal) water-cooled copper chill plate to produce inclined impacts, which shear the solidifying droplets into thin splat-quenched particulates. Typically, the splats have aspect ratios as high as 5:1, with a thickness in the range of 2 to 5 micrometers and produce metastable intermediate material in the form of crystalline or amorphous ceramic powders which are unattainable with prior art methods.

In an alternative embodiment of the present invention, coatings and preforms of metastable intermediate material can be produced by spraying the molten droplets of ceramic powder onto an inclined water-cooled copper chill plate or a steel substrate to produce inclined impacts or onto a perpendicular water-cooled copper chill plate to produce perpendicular impacts. Sheets up to about 0.5 inches thick can be made by carefully controlling the temperature of the chill plate to maintain the preferred cooling rate of ˜10⁶° K/sec. This can be accomplished by traversing the particle beam of the plasma spray gun back and forth over the surface of the chill plate, such that the preform is built up incrementally by the superposition of splat-quenched particulates. The resulting metastable intermediate material in the form of a sheet material contains a high degree of porosity, because of the nature of the incremental deposition process. However, most of this porosity consists of isolated pores which are easily eliminated by the subsequent pressure sintering step of the method.

When producing preforms, after the coating process is completed, the material is removed from the substrate and then cut into the desired preform shape. As an example, the sheet material can be cut into circular disks of several inches in diameter to feed into a conventional die and anvil. These blanks can then be sintered via the TAC process at a preferred pressure range of between 1.5 GPa and 8 GPa and at a preferred temperature range of between 25% and 60% of the melting point of the material. This approach allows the preliminary step of powder pre-consolidation to be advantageously eliminated, thereby avoiding coarsening of the microstructure that occurs during pressure-less sintering.

Coarse, micron-scale or fine, nano-scale ceramic powders, or mixtures thereof, can be used as feedstock powder for plasma spray processing, with essentially the same result because of the high temperatures in the plasma. Since the melting kinetics are somewhat faster for fine-grain powder, a mixture of coarse- and fine-grain powders can be used to generate a novel bimodal structure, composed of a uniform dispersion of unmelted micron-scale particles in a rapidly solidified nano-scale material composite ceramic matrix. Such bimodal ceramic structures should have property advantages that cannot be realized with unimodal structures.

When the starting ceramic compositions are mixed in ratios corresponding to the range of 60:40 to 40:60 mixtures of two ceramic phases under equilibrium conditions, the resulting sintered products have a bicontinuous, nano-scale grain size composite structure in which both phases form three-dimensional interconnected networks of the two phases wherein each network contains only one of the phases in a contiguous form. Formation of this structure may be preceded by a transient period of unrestricted growth of one or both equilibrium phases, after which the growth rate slows down dramatically, since one phase strongly impedes the growth of the other. The composite structure is further characterized by individual constituents with grain sizes of less than 100 nm; a second phase volume fraction which exceeds 5 volume percent; second phase particles homogeneously distributed along grain boundaries of the primary matrix phase so that each grain boundary of the primary phase is decorated by up to 10 second phase particles; and an average spacing between the second phase particles of no more than twice the average grain size of the primary phase. Thus, the properties and performance characteristics of the fully dense nanophase ceramic products are substantially improved, relative to all other known types of fine-ceramic materials.

Applicants believe that the transformation into the nanocomposite ceramic is initiated with the metastable intermediate phase thermally decomposing at elevated temperatures to produce a duplex structure composed of γ-Al₂O₃ and spinel phases, following an initial spinodal reaction. Upon further exposure to high temperature, the γ-Al₂O₃ phase changes into α-Al₂O₃ through a nucleation and growth mechanism resulting in a duplex structure composed of α-Al₂O₃ and other phases. It is believed that when the phase sequencing occurs under a compressive stress, the conditions induce prolific co-nucleation of γ-Al₂O₃ and spinel phases and facilitate the final phase transformation from γ-Al₂O₃ to α-Al₂O₃. The constituent phases of the resulting composite ceramic can exhibit grain sizes ranging from nanoscale to microscale dimensions depending on the decomposition temperature. It has been observed that the higher the temperature the coarser the composite structure. Depending on the application, the desired hardness can also be varied by adjusting the volume fraction of the ceramic phases without appreciably reducing toughness.

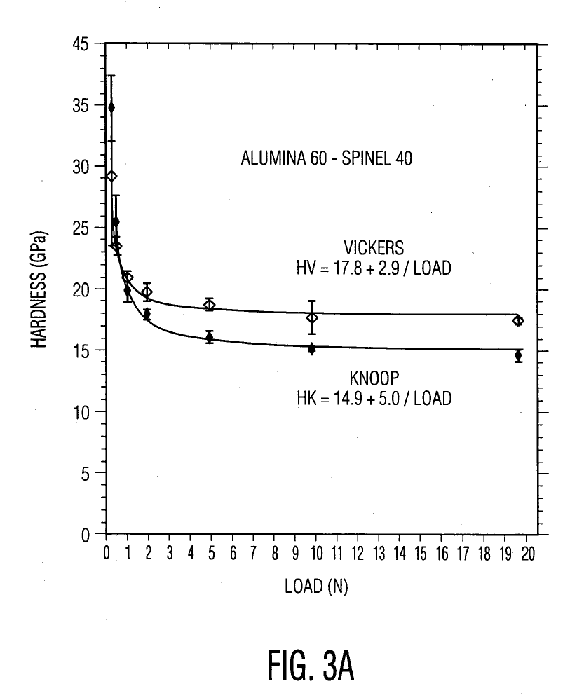

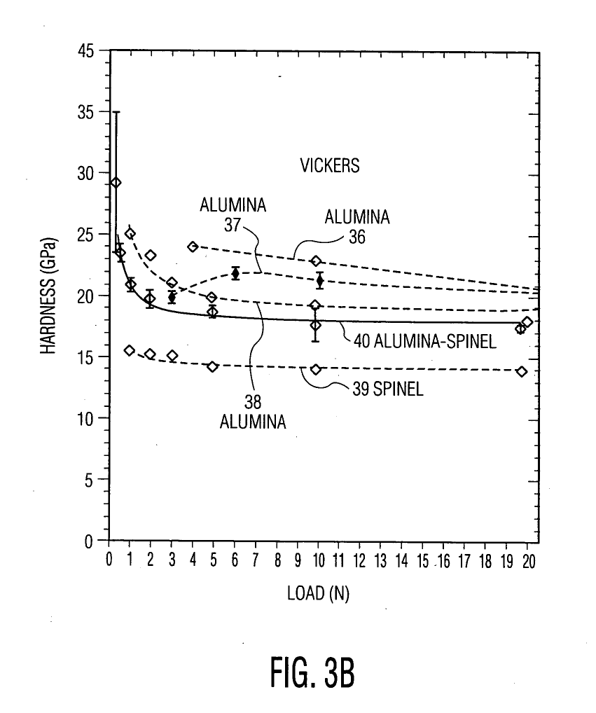

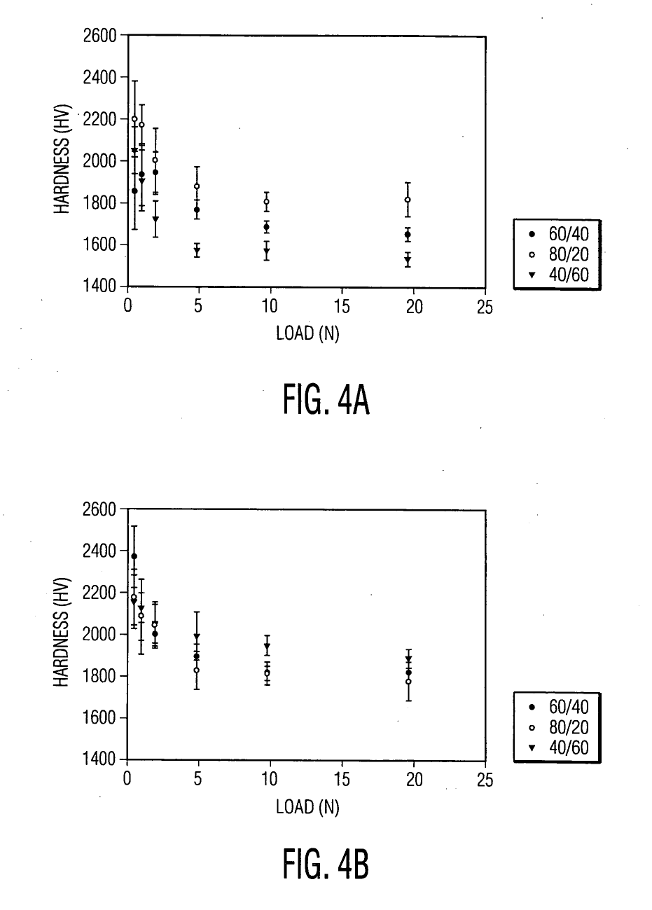

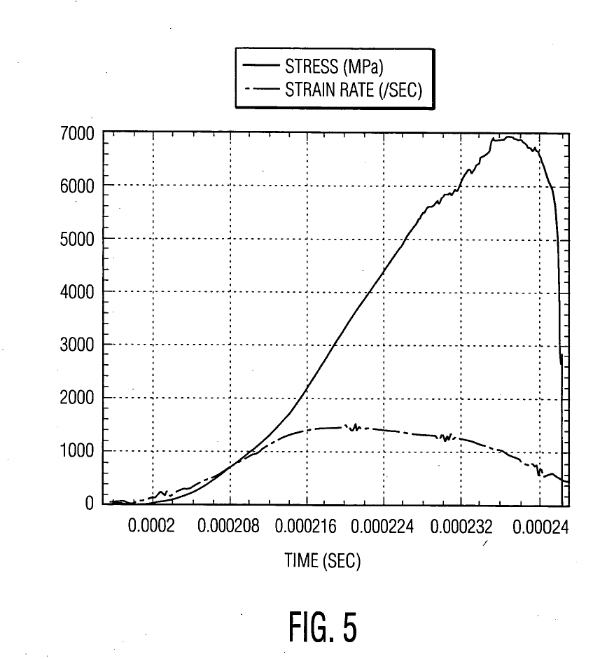

Two sets of samples with greater than 99.5% of theoretical density were evaluated for hardness over a wide range of loads. Data for the first set of samples, obtained at National Institute of Standards and Technology (NIST) using equipment that was calibrated versus multiple reference materials, are shown in FIG. 3A. As is typical of such hardness tests, the measured hardness decreases with increasing load to a constant value about 4-5 N. Hardness versus load data curve 40 for alumina-spinel for the present invention is compared with that of several commercially available armor-grade ceramics represented by curves 36 through 39 in FIG. 3B. Note that curves 36 through 38 are for alumina samples, and curve 39 is for a spinel sample. The hardness of the 60:40 alumina-spinel composite is comparable to that of high quality, fine-grained alumina, even though the composite contains a high fraction of the softer spinel phase. Data for the second set of samples relative to the present process are shown in FIGS. 4A and 4B. The higher hardness values of these samples relative to the present process are attributed to an improved microstructure, due to better control of the hot pressing of the melt-quenched metastable powder. As would be expected, the hardness of the alumina-spinel composite increases with the volume fraction of the hard alumina phase, but the effect is not large.

Scratch tests performed on these samples showed clear evidence for a “plowing action”, which is indicative of some plasticity in the micro-grained composite material. A similar effect has previously been reported for nano-grained WC/Co, in contrast to the disintegration experienced by phase-pure alumina under the same test conditions. In the WC/Co case, direct evidence for improved fracture toughness in the nanocomposite material, despite a much higher hardness, has also been observed. A similar behavior for the alumina-spinel composite seems likely, but this needs to be confirmed. However, it has been observed that in an indentation toughness test, the cracks followed an irregular path, consistent with cracking along prior particle boundaries.

When failure occurs in a bulk sample, propagating cracks should, therefore, follow tortuous paths along the many prior particle boundaries, with many stops and starts, as the crack-tips change directions with respect to the applied stress. Such behavior should increase the fracture toughness of the composite ceramic. A high hardness combined with good fracture toughness should enhance ballistic performance, but this needs to be verified. The highest priority, therefore, is being given to obtaining fracture toughness data on fully dense composite samples, with grain sizes of the constituent phases ranging from nano- to micro-scale dimensions.

Preliminary high strain rate data as shown in FIG. 5, using a Split-Hopkinson Pressure Bar test for Al₂O₃-20 vol. % MgAl₂O₄, indicate a strength that is significantly better than anticipated. The expected value for armor-grade Al₂O₃ would fall within the range 3.0-4.0 GPa. Testing indicated results between 4.5-6.7 GPa. There has also been some speculation that the shape of the curves may indicate the presence of some plasticity, though this has not yet been proved.

Although various embodiments of the invention have been shown and described, they are not meant to be limiting. Those of skill in the art may recognize certain modifications to the invention as taught, which modifications are meant to be covered by the spirit and scope of the appended claims.

For those skilled in the art, it will be recognized that many similar combinations of oxide ceramics, with comparable volume fractions of the constituent phases, would display similar mechanical behavior. Examples are MgO+Y₂O₃, ZrO₂+Y₂O₃, and Al₂O₃+ZrO₂, or mixture thereof.

What is claimed is:

1. A nanocomposite ceramic comprising a uniform combination of at least two hard ceramic phases, wherein each phase exhibits an average grain size of less than 10,000 nm.

2. The nanocomposite ceramic of claim 1, wherein the at least two hard ceramic phases comprises a ceramic spinel phase and an alumina phase.

3. The nanocomposite ceramic of claim 1, wherein the average grain size is from about 0.1 nm to 10,000 nm.

4. The nanocomposite ceramic of claim 1, wherein the average grain size is less than 100 nm.

5. The nanocomposite ceramic of claim 4, wherein the average grain size is from about 0.1 nm to 100 nm.

6. The nanocomposite ceramic of claim 2, wherein the alumina phase is α-alumina.

7. The nanocomposite ceramic of claim 2, wherein the ceramic spinel phase has a general formula of (X²⁺)(Al³⁺)₂(O²⁻)₄, with X representing a divalent cation.

8. The nanocomposite ceramic of claim 7, wherein X is selected from the group consisting of magnesium, zinc, iron, and manganese.

9. The nanocomposite ceramic of claim 2, wherein the ceramic spinel phase is an aluminate.

10. The nanocomposite ceramic of claim 9, wherein the aluminate is magnesium aluminum oxide.

11. The nanocomposite ceramic of claim 2, wherein the combination comprises a volume fraction ratio of alumina:spinel in the range of from about 60-40:40-60.

12. The nanocomposite ceramic of claim 2, wherein the combination comprises a bicontinuous structure, wherein the ceramic spinel phase and the alumina phase are interwoven in three dimensions.

13. The nanocomposite ceramic of claim 2, wherein the combination comprises a volume fraction ratio of alumina:spinel in the range of from about 90-60:10-40 and from about 10-40:90-60.

14. The nanocomposite ceramic of claim 1, wherein the combination comprises a particle-dispersed structure wherein the minor fraction is a dispersed phase and the major fraction is a matrix phase.

15. A method for fabricating a nanocomposite ceramic of claim 1, comprising:
transforming a ceramic feed material comprising at least two hard ceramic phases into a metastable crystalline phase having an amorphous, short-range order structure; and
sintering the metastable crystalline phase under elevated pressures and temperatures for a sufficient time to yield the nanocomposite ceramic.

16. The method ceramic of claim 15, wherein the at least two hard ceramic phases comprises a ceramic spinel phase and an alumina phase.

17. The method of claim 15, wherein the metastable crystalline phase is in a form selected from the group consisting of a powder, a coating, a deposit and a preform.

18. The method of claim 15, wherein the ceramic feed material is in the form selected from the group consisting of a powder and an aerosol of a precursor solution.

19. The method of claim 18, wherein the ceramic feed material comprises particles having an average particle size of from about 0.1 micrometer to 200 micrometer.

20. The method of claim 19, wherein the average particle size is from about 0.1 micrometer to 50 micrometer.

21. The method of claim 19, wherein the average particle size is from about 5 micrometer to 100 micrometer.

22. The method of claim 19, wherein the average particle size is from about 10 micrometer to 200 micrometer.

23. The method of claim 18, wherein the ceramic feed material is in the form of a powder.

24. The method of claim 23, wherein the transforming step comprises:
melting the ceramic feed material to yield molten particles; and
quenching the molten particles rapidly to yield the metastable crystalline material.

25. The method of claim 24, prior to the transforming step, further comprising:
spray drying the ceramic feed material; and
heat treating the ceramic feed material at a sufficient temperature and for a sufficient time to remove organic impurities therefrom, and enhance structural strength to the particles of the ceramic feed material.

26. The method of claim 24, wherein the melting step comprises injecting the ceramic feed material into a high enthalpy plasma flame.

27. The method of claim 26, wherein the ceramic feed material is injected axially into the high enthalpy plasma flame.

28. The method of claim 26, wherein the ceramic feed material is injected radially into the high enthalpy plasma flame.

29. The method of claim 26, further comprising enclosing the high enthalpy plasma flame in a tubular heat resistant, refractory shroud.

30. The method of claim 24, wherein the quenching step comprises depositing the molten particles into a cold water bath.

31. The method of claim 24, wherein the quenching step comprises depositing the molten particles onto a cold substrate.

32. The method of claim 24, wherein the quenching step comprises delivering the molten particles through a supersonic nozzle.

33. The method of claim 18, wherein the ceramic feed material is in the form of an aerosol of a precursor solution.

34. The method of claim 33, wherein the transforming step comprises:
vaporizing the ceramic feed material to yield vaporized particles; and
condensing the vaporized particles rapidly to yield the metastable intermediate material.

35. The method of claim 34, wherein the vaporizing step comprises injecting the ceramic feed material into a high enthalpy plasma flame.

36. The method of claim 35, wherein the ceramic feed material is injected axially into the high enthalpy plasma flame.

37. The method of claim 35, wherein the ceramic feed material is injected radially into the high enthalpy plasma flame.

38. The method of claim 35, further comprising enclosing the high enthalpy plasma flame in a tubular heat resistant, refractory shroud.

39. The method of claim 34, wherein the condensing step comprises quenching the vaporized particles into a cold water bath.

40. The method of claim 34, wherein the condensing step comprises quenching the vaporized particles on a cold substrate.

41. The method of claim 34, wherein the condensing step comprises delivering the vaporized particles through a supersonic nozzle.

42. The method of claim 15, wherein the ceramic feed material comprises a mixture of alumina and the spinel.

43. The method of claim 15, wherein the ceramic feed material comprises an aluminum containing phase and a magnesium containing phase.

44. The method of claim 43, wherein the aluminum containing phase comprises aluminum trihydrate.

45. The method of claim 43, wherein the magnesium containing phase is magnesium carbonate.

46. The method of claim 15, wherein the ceramic feed material comprises an oxide.

47. The method of claim 46, wherein the oxide is selected from the group consisting of magnesium oxide, zinc oxide, iron oxide, and manganese oxide.

48. The method of claim 47, wherein the oxide is magnesium oxide.

49. The method of claim 15, wherein the pressure-assisted sintering is in the range of from about 0.1 to 5 GPa.

50. The method of claim 49, wherein the pressure-assisted sintering is in the range of from about 0.1 to 3 GPa.

51. The method of claim 15, wherein the pressure-assisted sintering temperature is in the range of from about 25% to 60% of the melting point of the metastable intermediate material.

52. The method of claim 15, wherein the pressure-assisted sintering time is in the range of from about 15 minutes to 14 hours.

53. The method of claim 15, wherein the sintering time is in the range of from about 15 minutes to 8 hours.
